(19) United States
(12) Patent Application Publication
(10) Pub. No.: US 2011/0204794 A1
(43) Pub. Date: Aug. 25, 2011

(54) Light control device for public lighting lamps

(75) Inventor: Gian Pietro Beghelli, Monteveglio (IT)

(73) Assignee: BEGHELLI S.p.A., Monteveglio (IT)

(21) Appl. No.: 12/930,393

(22) Filed: Jan. 5, 2011

(30) Foreign Application Priority Data
Feb. 24, 2010 (IT) VI2010A 000045

(51) Int. Cl. H05B 37/02; F21V 7/00

(52) U.S. Cl. 315/152; 362/235

(57) ABSTRACT

A light control device for public lighting lamps (31), installed on carriageways (32) and provided with at least one light emitter (30) comprising a plurality of light sources (35) and a plurality of reflectors or mirrors (38, 39) housed inside at least one casing laterally bounded by closure sides (41, 42); in particular, reflectors or mirrors (38, 39) include a first set of reflectors (38) having a surface with fixed inclination and a second set of reflectors (39) having surface with adjustable inclination, wherein the reflectors (39) with adjustable inclination are pivoted on relative shafts (40), which are sliding along fixed cams (43) that correspond to respective grooves made in said closure sides (41, 42) and in the lateral walls of a sliding lever (44), which, by shifting with respect to the sides (41, 42), with said cams (43) fixed, causes the inclination of the aforesaid second set of reflectors (39).

The present invention generally relates to a light control device for public lighting lamps.

Street lamps are currently, which can be used in particular for street lighting and uses, as light source, power emitting modules, such as LEDs, with integrated optics and/or heat sink, suitable to ensure a low environmental impact, due to the lower electricity consumption which LEDs need for power supply, compared to the conventional incandescent gas lamps.

Some of the aforesaid public LEDs lighting lamps of known type also comprise a containment envelope or casing, which protects the LEDs light sources and other components, such as a radio control electronic feeder, a plurality of longitudinal and/or transverse mirrors or reflectors and possible accessory sensors for measuring traffic conditions and/or environmental parameters.

Moreover, according to illustrative and preferred embodiments, the power emitting LEDs are connected in series within respective strings, independent each other, and incorporate asymmetric and/or symmetric type lenses, suitable to direct the light radiation, further reflected by the mirrors, according to desired directions and areas.

These public lighting devices offer high energetic efficiency, at the same time also reducing electricity consumption, but very unlikely allow, during installation, to optimally adapt their own optical features to the carriageway configuration.

Indeed, it must be noted that in the street lighting various lighting profiles are available, each peculiar of a different configuration of the carriageway to be light, and which, in particular, at least two typical scenarios of street lighting exist, such as:
a lighting with “surround lighting”, according to which the street lamp must properly direct ⅔ of the total luminous flux on the carriageway (according to the requirements defined for the type of road) and the remaining ⅓ of the total luminous flux must be directed to light the side bands adjacent to the carriageway for a width of 5 m on each side (this latter “surround” light is intended to make less clear the separation between the carriageway and shoulder and to light also the shoulder and pavement where this is necessary), and
a lighting without “surround lighting”, according to which the total emitted luminous flux is directed to the carriageway and there is no minimum amount of residual light distributed on the sides of the carriageway itself.

It is obvious that the second case corresponds to a more efficient street lamp, since all the light is substantially directed where it is needed, however in practice there are many cases in which the “surround” lighting is necessary, although such cases are not always easily predictable at design phase and/or before the actual installation.

Within the above mentioned requirements, purpose of the invention is, therefore, to create a light control device for public lighting lamps, which allows, during installation of the lighting lamp, to modify the light radiation pattern optimally adapting its features to the carriageway configuration.

Another purpose of the present invention is to provide a light control device for public lighting lamps, which allows to obtain even an adjustment of the “surround” lighting, which can be performed by the user during the installation of the lamp.

Another purpose of the invention is to devise a light control device for public lighting lamps, which allows to get, in any case, the maximum possible luminous efficiency of the lighting lamp and, at the same time, the maximum possible energy saving in any condition, compared to the prior art.

Further purpose of the present invention is to provide a light control device for public lighting lamps, which is extremely reliable over time, efficient and functional to any need, as well as easy and quick to be installed and inexpensive to be produced.

These and other purposes, according to the present invention, are achieved through a light control device for public lighting lamps, according to the attached claim 1.

### BRIEF DESCRIPTION OF THE SEVERAL VIEWS OF THE DRAWINGS

FIG. 1 is a top perspective view of a light emitter according to the invention;

FIG. 2 is another perspective view of the light emitter of FIG. 1;

FIG. 3 is another perspective view of the light emitter of FIG. 1;

FIG. 4 is another perspective view of the light emitter of FIG. 1;

FIG. 5 is a cut-a-way sectional view of the light emitter of FIG. 1;

FIG. 6 is a cut-a-way, sectional view of the light emitter of FIG. 1;

FIG. 7 is a partial end view of FIG. 1;

FIG. 8 is another partial end view of FIG. 1;

FIG. 9 is a top perspective view of the light emitter of the invention;

FIG. 10 is a top perspective view of a light emitter of the invention;

FIG. 11 is a perspective view of an embodiment of the light control device lever;

FIG. 12 is a perspective view of the operation of the light control device of the invention;

FIG. 13 is an enlarged section of FIG. 12;

FIG. 14 is a perspective view of the operation of the light control device in an initial position;

FIG. 15 is a perspective view of the operation of the light control device in an intermediate position;

FIG. 16 is a perspective view of the operation of the light control device in a final position;

FIG. 17 is a view of an alternative operation of the light control device in an initial position;

FIG. 18 is a view of an alternative operation of the light control device in a final position;

FIG. 19 is a view of an alternative operation of the light control device in an initial position;

FIG. 20 is a view of an alternative operation of the light control device in a final position;

FIG. 21 is an initial view of an alternative operation of the light control device in an initial position;

FIG. 22 is an initial view of an alternative operation of the light control device in a final position;

FIG. 23 is an isolux diagram of the public lighting lamp, to which the light control device according to the invention is applied, in a first illumination mode;

FIG. 24 is an isolux diagram of the public lighting lamp, to which the light control device according to the invention is applied, in a second illumination mode.

Further embodiments of detail are described in the subsequent dependent claims.

Advantageously, according to the present invention, it is provided to control a plurality of longitudinal mirrors or reflectors of the public lighting lamp or street lamp, which allows, during lamp installation, to modify the light radiation pattern, optimally adapting its features to the carriageway configuration.

The device thus allows to include a light control of the “surround” lighting, which can be performed by the user during installation, always getting the highest possible luminous efficiency of the lamp, and, thus, the maximum possible energy saving in every condition.

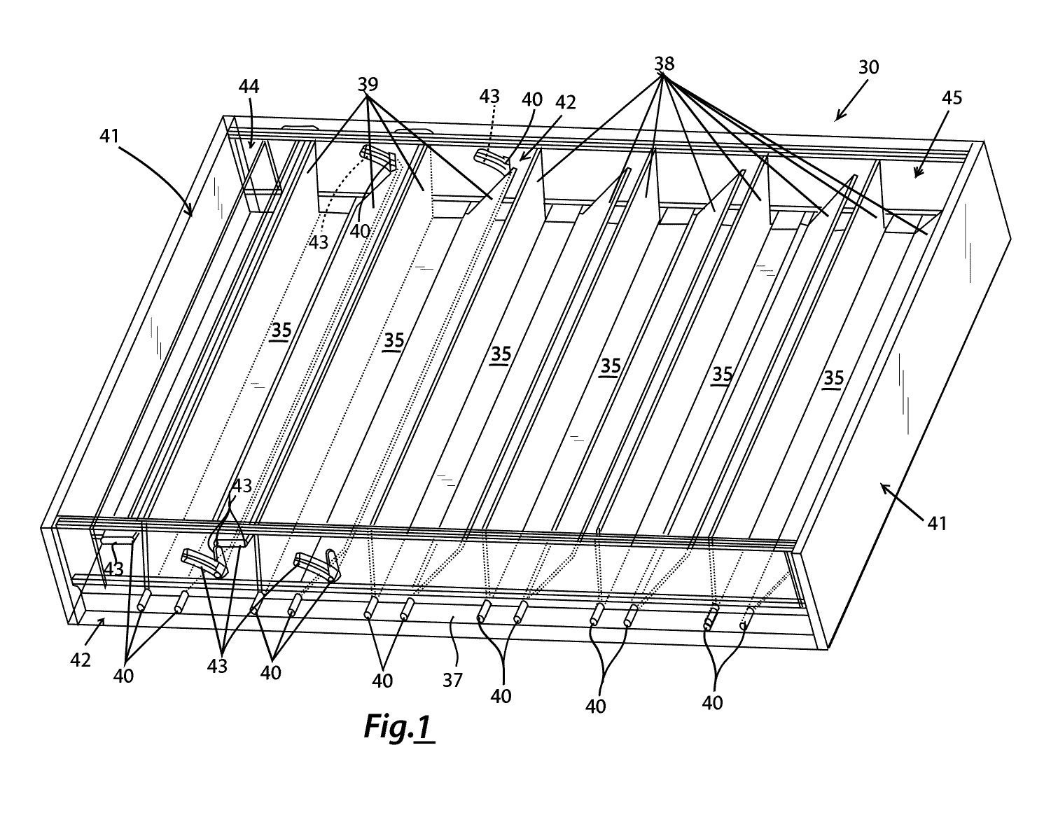

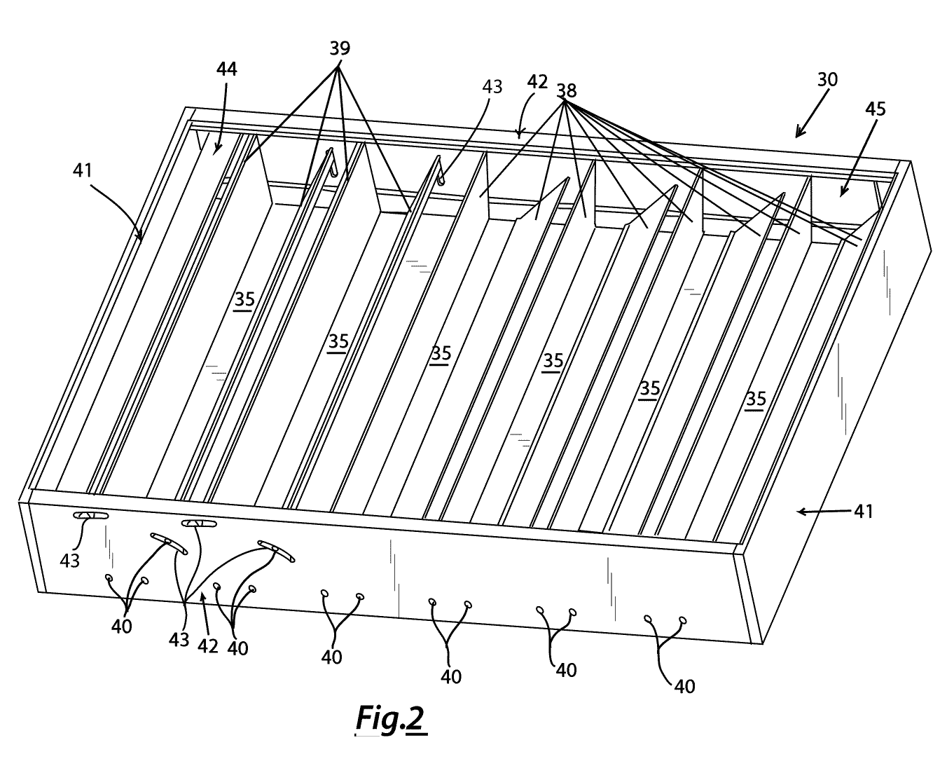

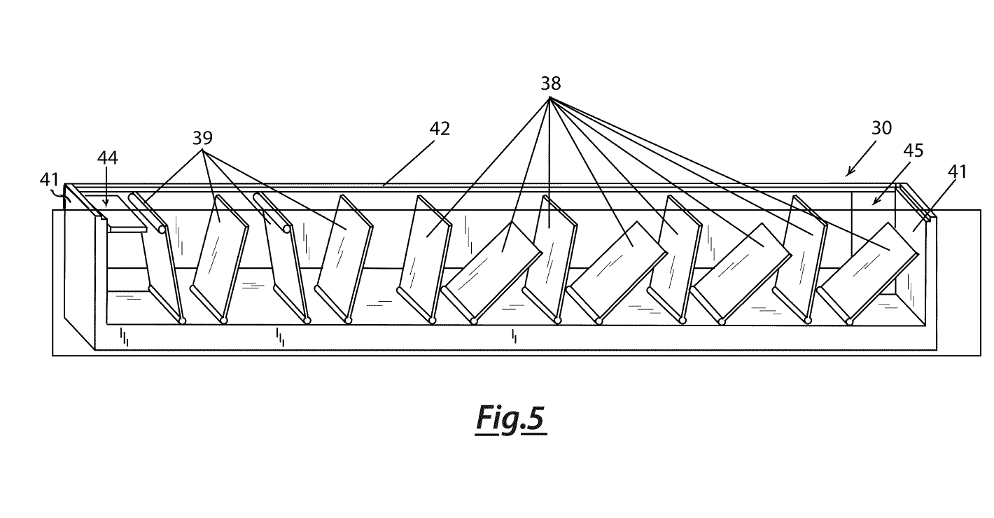

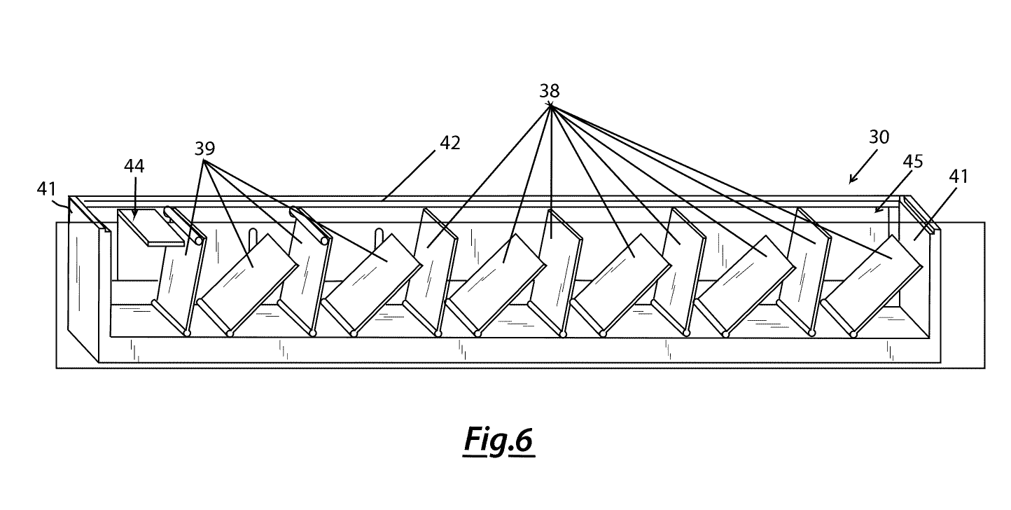

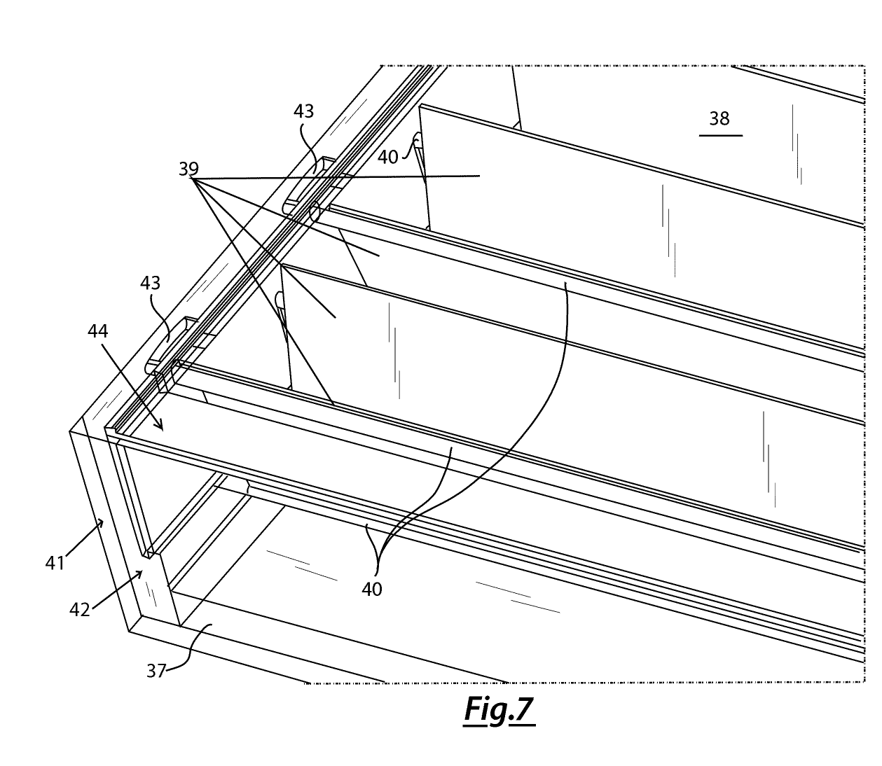

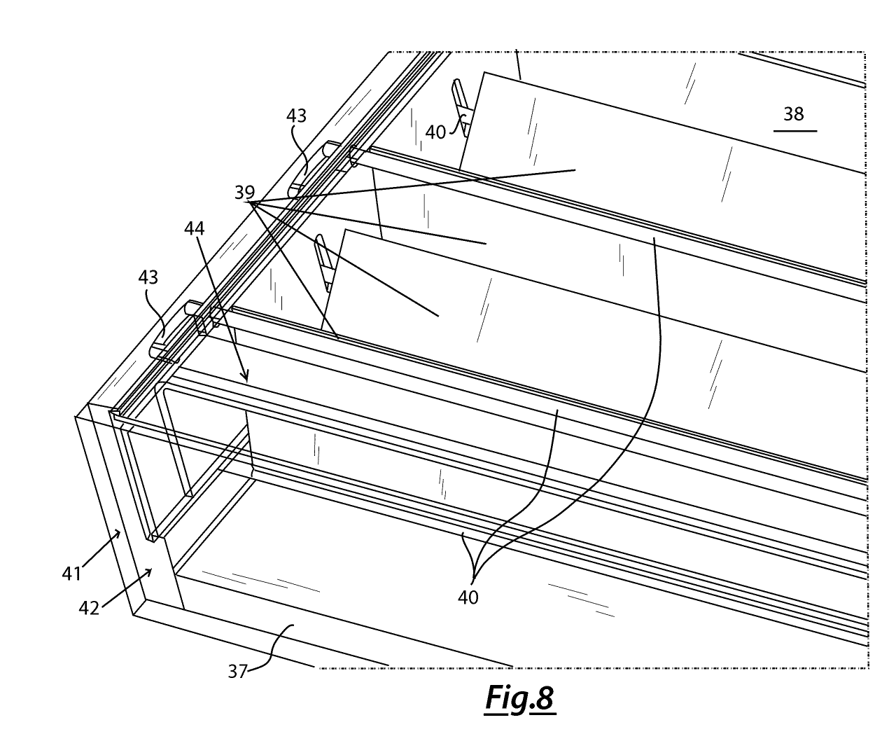

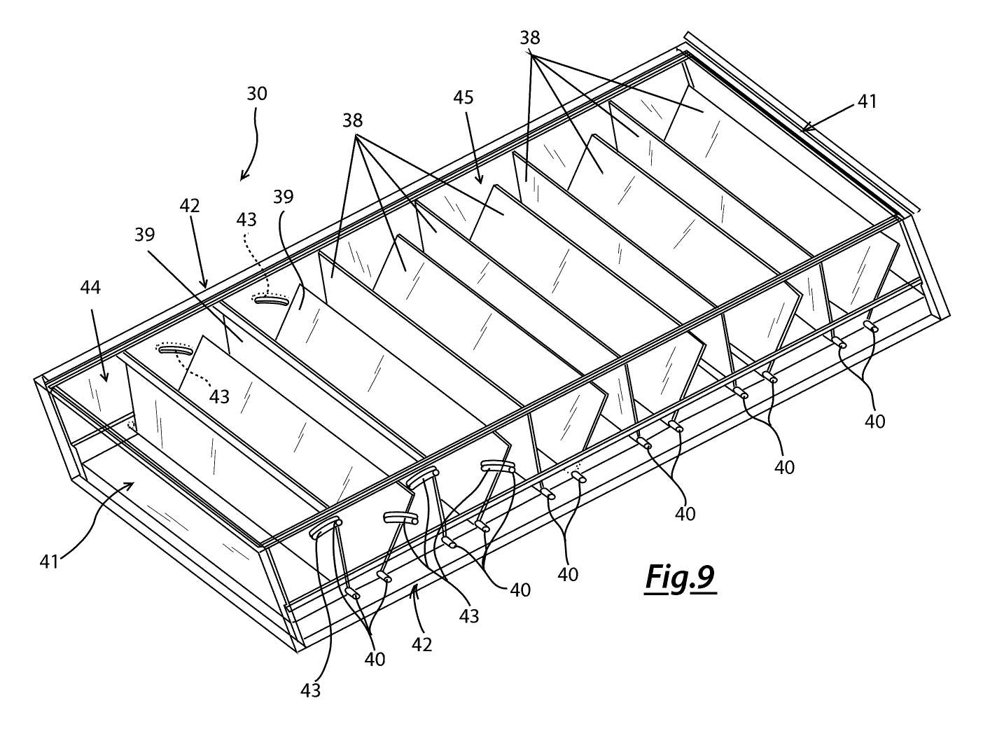

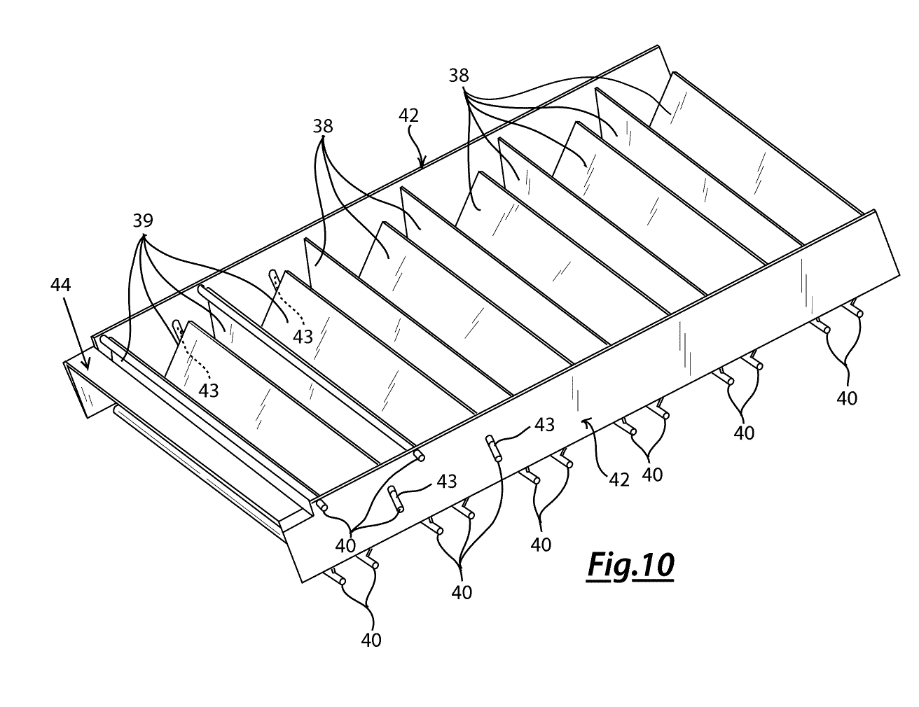

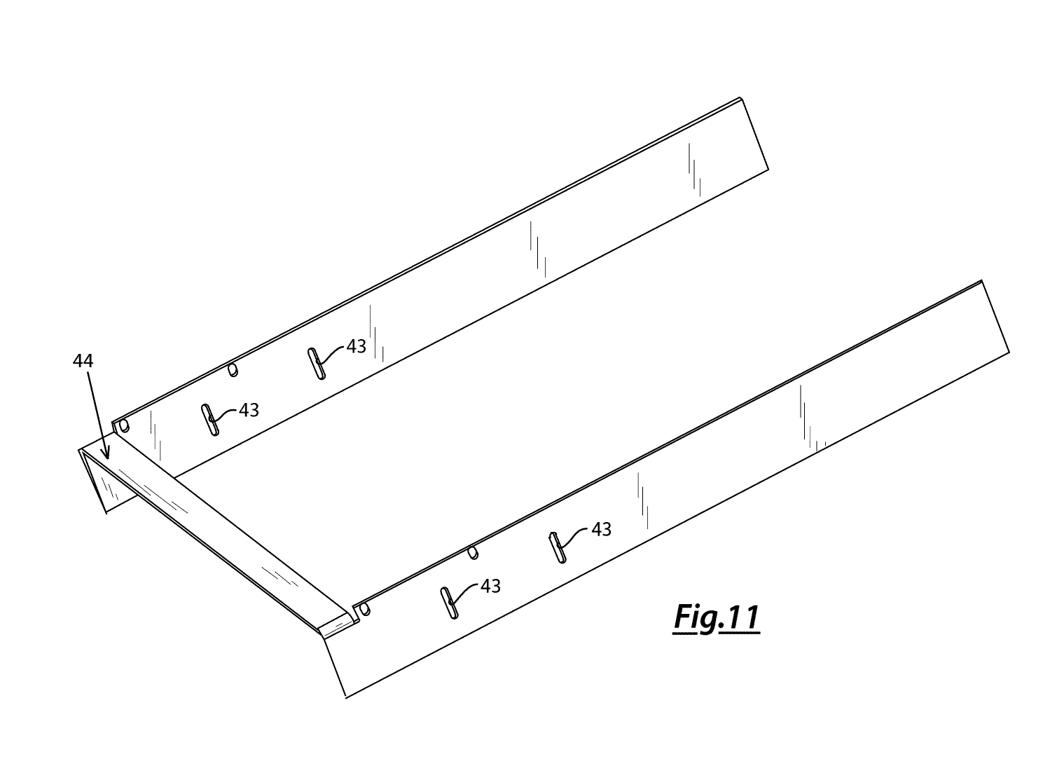

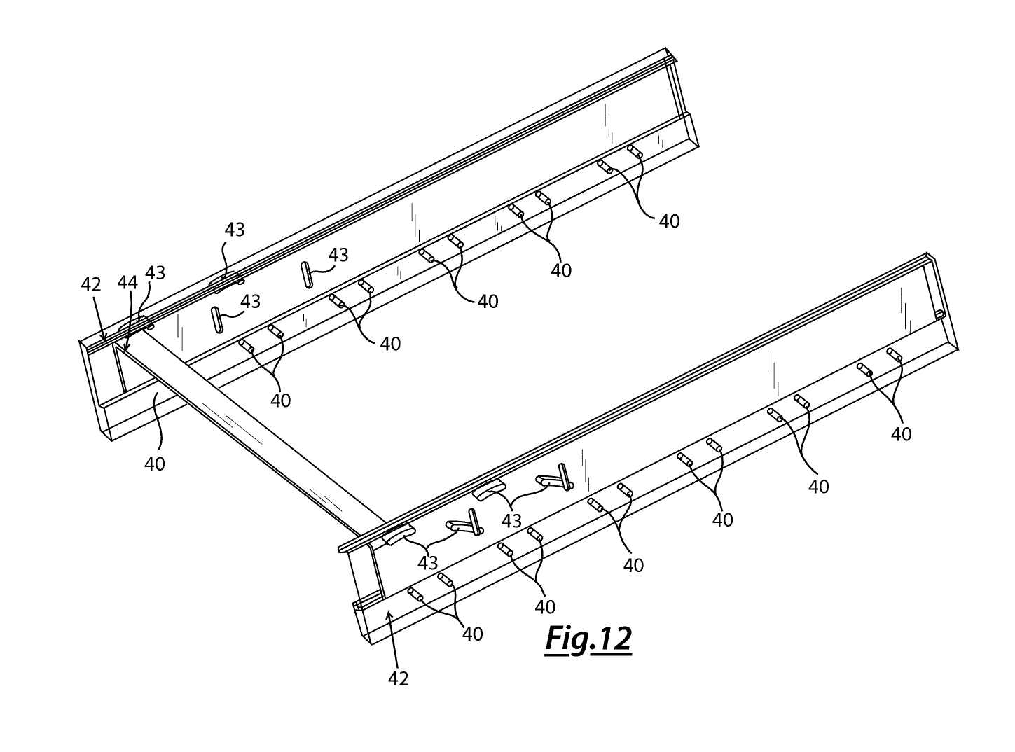

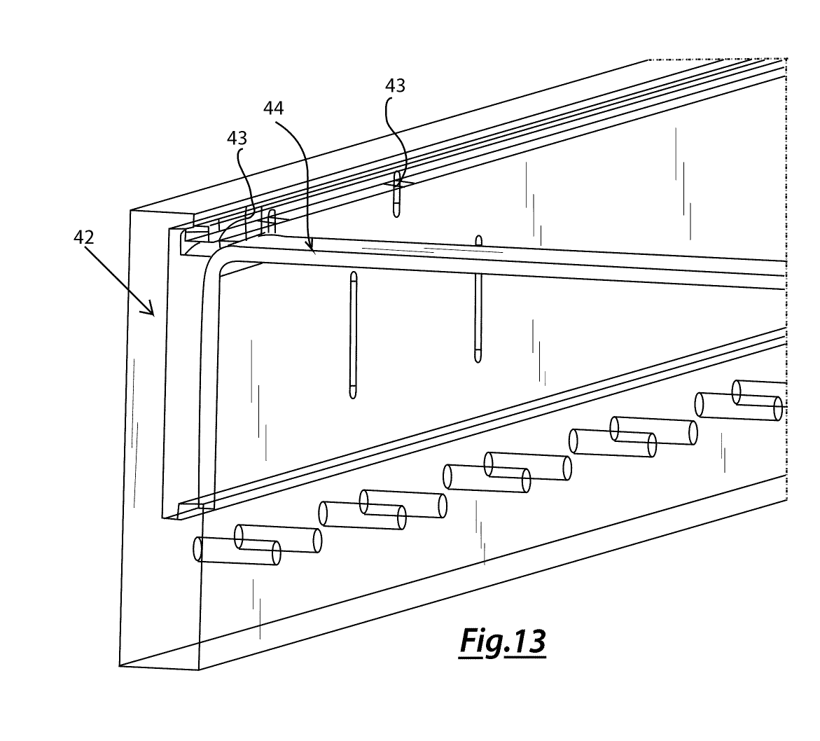

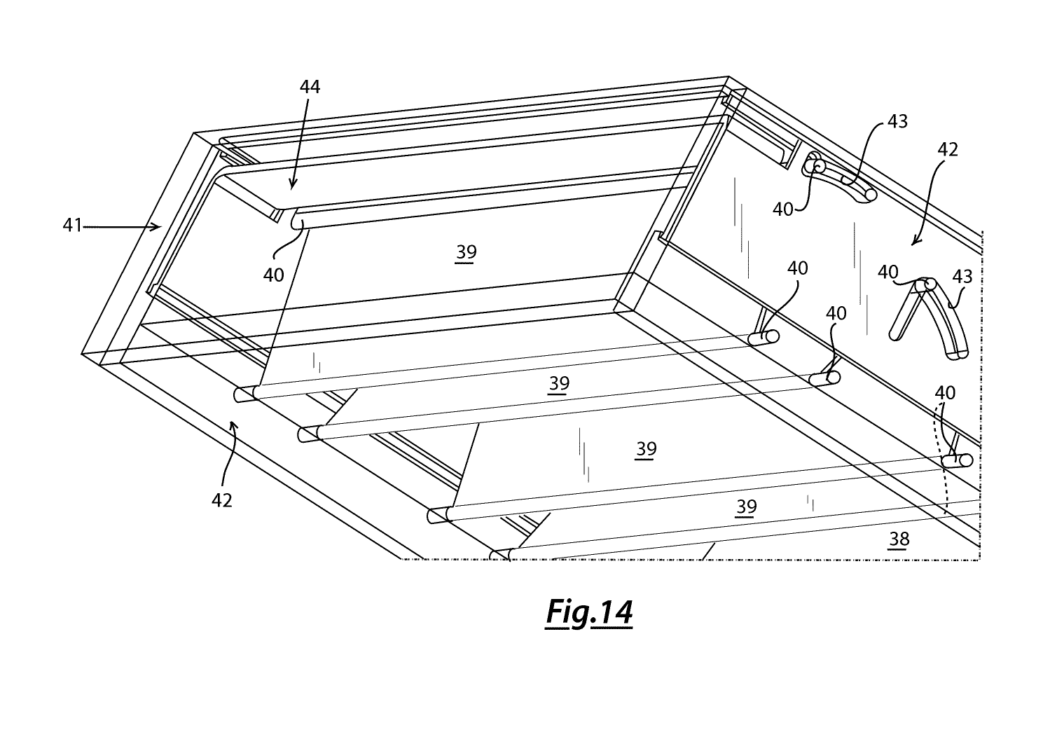

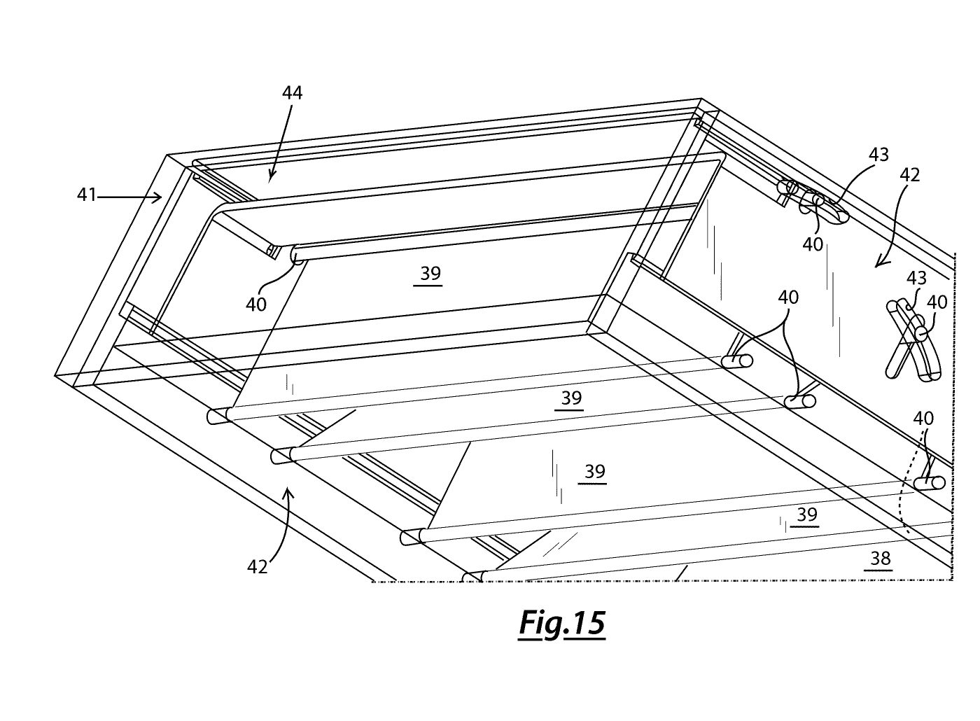

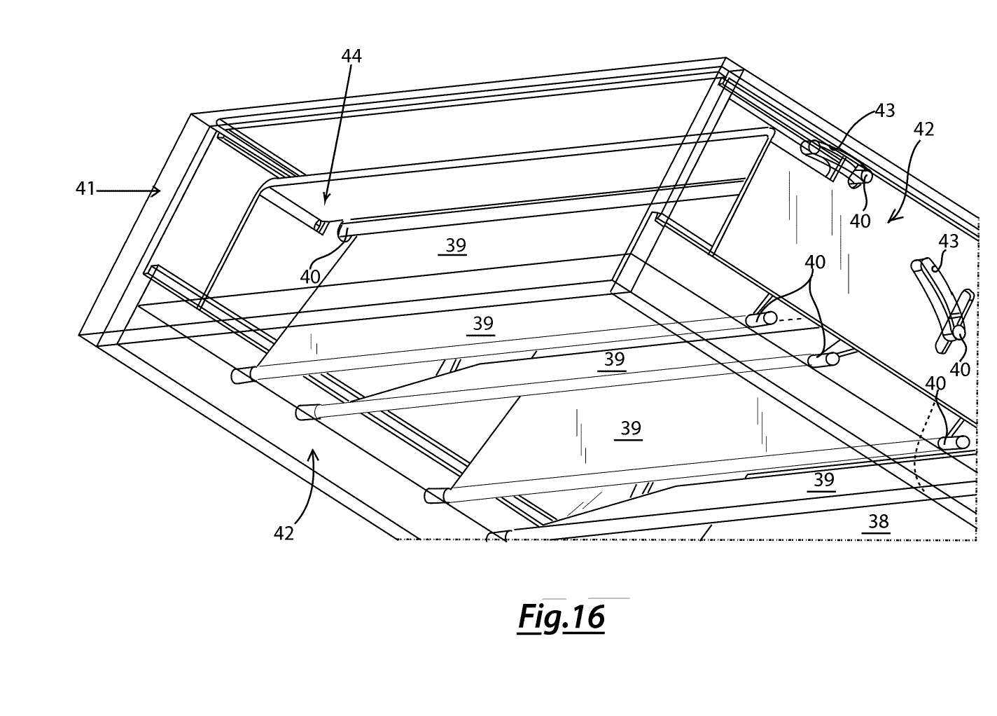

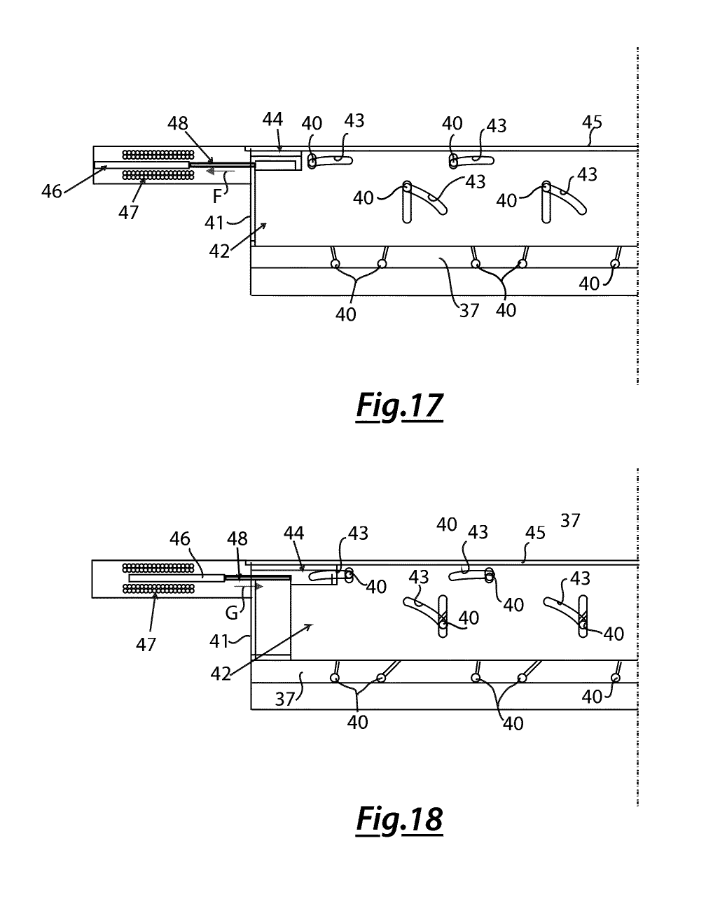

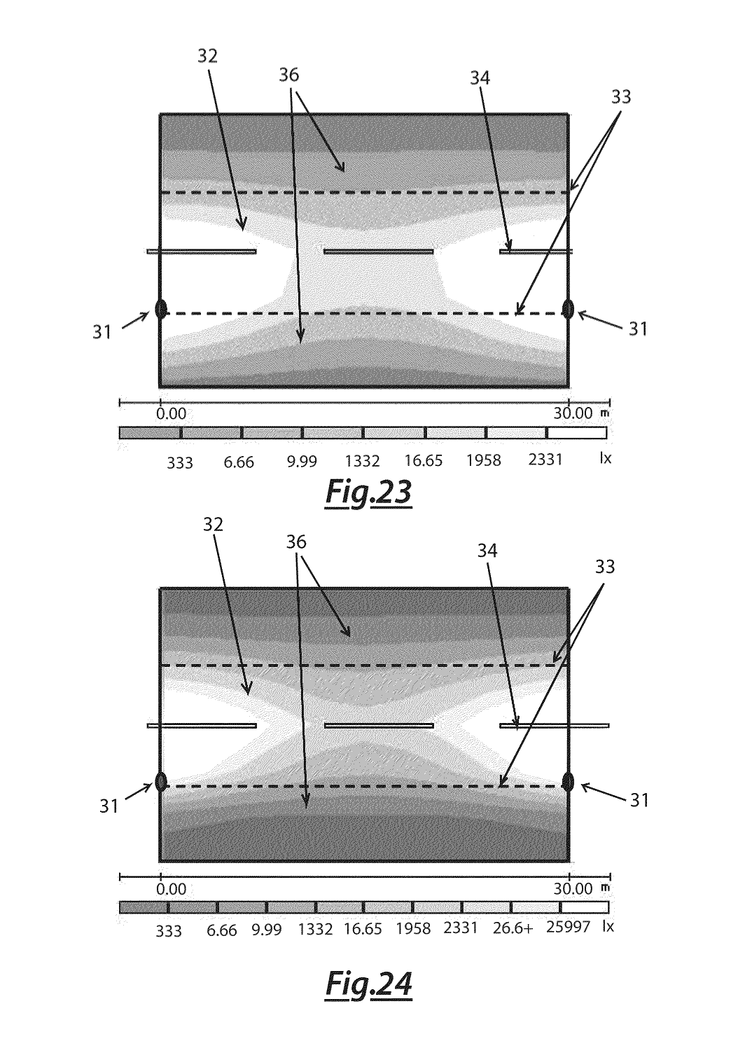

Additional features and advantages of a light control device for public lighting lamp, according to the present invention, will be more evident from the following description, relating to its preferred and illustrative, but not exhaustive, embodiment and the accompanying drawings, in which:
FIG. 1 shows a first perspective view from the top of the light emitter of a public lighting lamp, to which the light control device, according to the invention, can be applied;
FIGS. 2, 3 and 4 show as many perspective views from the top of the emitter of the public lighting lamp of FIG. 1, according to the present invention, with the reflectors oriented according to different positions;
FIGS. 5 and 6 show as many section views of the emitter of the public lighting lamp of FIG. 1, according to the present invention, with the reflectors oriented according to prefixed different positions;
FIGS. 7, 8, 9 and 10 show a plurality of details of the light control device applied to the public lighting lamp of FIG. 1, according to the present invention;
FIG. 11 shows a perspective view of an embodiment of a lever of the light control device for public lamp, made in accordance with the present invention;
FIG. 12 shows a perspective detail view of the operation of the light control device, according to the invention;
FIG. 13 shows an enlarged detail of FIG. 12, according to the present invention;
FIGS. 14, 15 and 16 show as many perspective detail views of the operation of the light control device, illustrated, respectively, in an initial position, in an intermediate position and in a final position, in accordance with the present invention;
FIGS. 17, 18, 19, 20, 21 and 22 show as many section detail views of alternative operations of the light control device, illustrated, respectively, in an initial position and in a final position, in accordance with the present invention;
FIG. 23 shows an earth-putted isolux diagram of the public lighting lamp, to which the light control device according to the present invention is applied, in a first illumination mode with “surround lighting”;
FIG. 24 shows an earth-putted isolux diagram of the public lighting lamp, to which the light control device according to the invention is applied, in a second illumination mode without “surround lighting”.

With reference to the mentioned figures, a public LEDs lighting lamp, which uses a control device of the light radiation pattern, according to the present invention, essentially comprises:
a light radiation emitter 30 which includes a bottom plate 37, suitable to support an IMS (Insulated Metal Substrate) printed circuit board where the power emitting LEDs, used as light sources of the aforesaid public lighting lamp and placed at the positions indicated with 35 in FIG. 1, are housed;
a plurality of twelve reflectors or mirrors, eight of which (indicated with the reference 38) fixed and four (indicated with the reference 39) with adjustable inclination;
a plurality of shafts 40 onto which the adjustable mirrors or reflectors 39 are hinged;
two, front and rear, closure sides two side panels 41 and two lateral sides 42, having notches corresponding to the profiles of the fixed cam 43;
a sliding lever 44, which, by translating with respect to the sides 42 with the fixed cam 43, causes different inclinations of the reflectors or mirrors 39;
an upper closing glass 45.

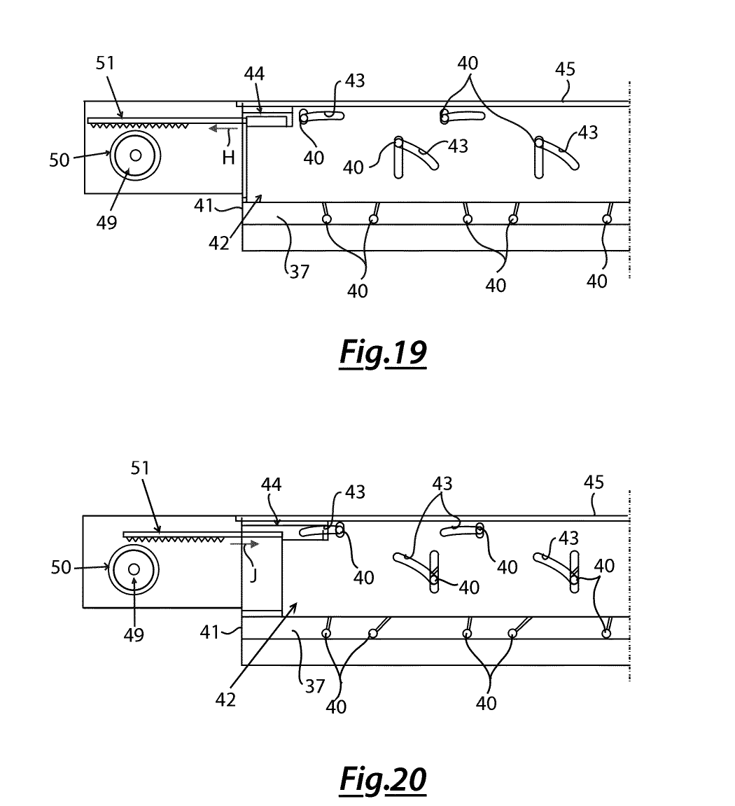

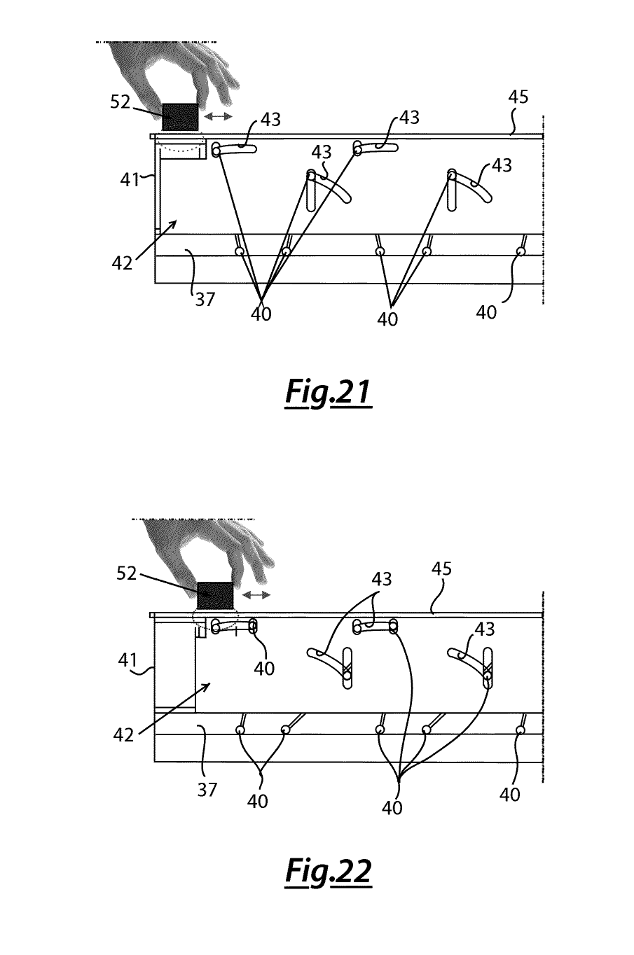

FIGS. 17 and 18 show a control method of the light adjusting which can be made electronically by means of electromagnetic actuators, the FIGS. 19 and 20 show a control method of the light adjusting which can be made electronically by means of a mini-electric motor, while FIGS. 21 and 22 shows a control method of the light adjustment which can be made manually by means of a magnet; finally, FIGS. 23 and 24 show earth-putted isolux diagrams of the public street lighting lamp in the various possible adjustments.

The light radiation emitter 30 with LEDs 35 is constructed in such a way as all the elements composing it are contained inside a case sealed against atmospheric agents.

Indeed, as shown in FIGS. 1-16, the mirrors or reflectors 38, 39, shafts 40, LEDs 35 and sliding lever 44 of displacement of the mirrors 38, 39 are all incorporated in the casing formed by the bottom plate 37, closure sides 41 and lateral sides 42 of the upper glass 45.

As visible in detail in FIGS. 1-16, the lateral sides 42 are punched and have leaks corresponding to the fixed cams 43, but also these leaks will be closed in the finished product, since, at closure sides 42, when the street lamp is completed, the heat sinks are mounted which close these leaks achieving the complete sealing of the emitter 30.

The operation of the light control device for public lighting lamp, according to the present invention, is basically as follows.

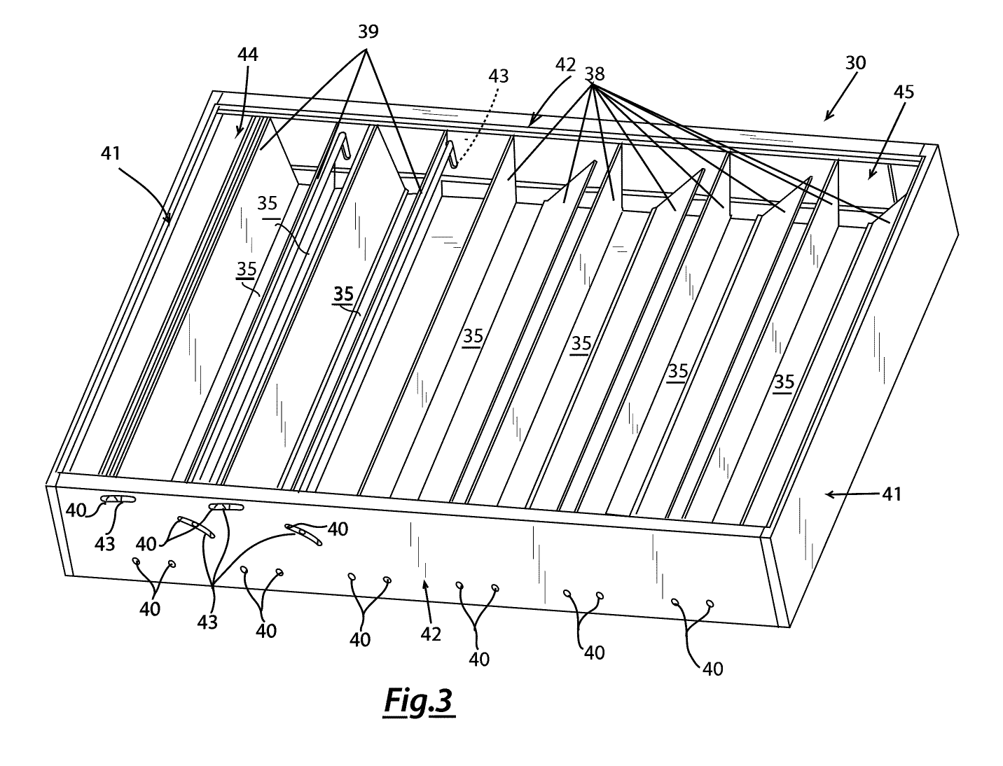

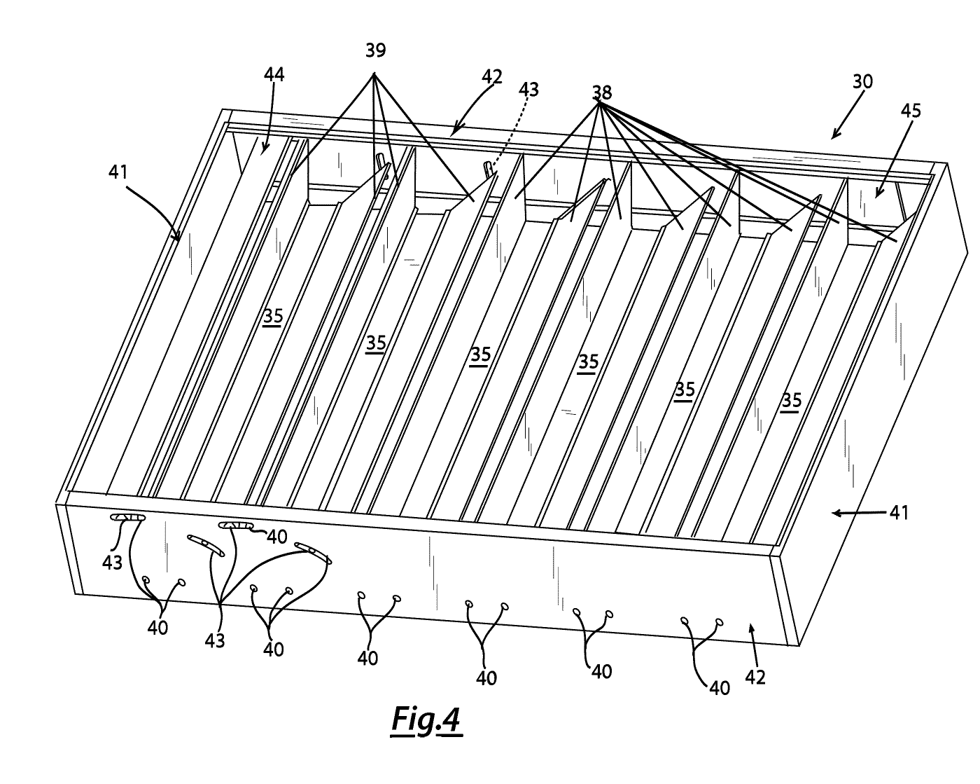

With particular reference to FIGS. 3-6, the longitudinal mirror 39 (which, in preferred and illustrative, but not limiting, embodiments of the invention, are oriented in a direction parallel to the carriageway) can be sloped as in the position referred to FIGS. 3 and 5 or in the position referred to as FIGS. 4 and 6 and/or in the intermediate positions between the two aforesaid extreme positions.

In particular, in the position illustrated in FIGS. 3 and 5, the two pairs of adjustable mirrors 39 are sloped differently from the other four pairs of fixed mirrors 38 and the inclination of the two pairs of mirrors 39 is designed so as to direct the light of the two rows of corresponding LEDs 35, both in the carriageway 32 and towards the side areas or edge areas 36 of the carriageway 32, in order to light part of the shoulder or pavement (“surround lighting”) too.

The other four pairs of fixed reflectors 38 are oriented so as to direct the light inside the carriageway 32, avoiding at maximum light dispersions in the side areas 36 of the carriageway 32.

As result, the overall combination provides the light diagram of the appended FIG. 23, which shows an earth-putted isolux diagram of a typical installation of the public lighting lamp or street lamp 31, according to the present invention, with the adjustable mirrors 39 of the emitter 30 in the position of FIGS. 3 and 5.

In the position illustrated in FIGS. 4 and 6, the two pairs of adjustable mirrors 39 are inclined as the other four pairs of fixed mirrors 38 and, in this case, the inclination of all the six pairs of reflectors 38, 39 is such that to direct all the light inside the carriageway 32, avoiding at maximum dispersions in the side areas 36 of the carriageway 32, like the shoulder or pavement; in such a position, all the six pairs of mirrors 38, 39 contribute to keep the light inside the carriageway 32, as illustrated by the luminous diagram of the attached FIG. 24, showing the isolux diagram of a typical installation of the public lighting lamp 31, according to the invention, with the mirrors 38, 39 of the emitter 30 in the position of FIGS. 4 and 6.

The diagrams shown in the appended FIGS. 23 and 24 schematically illustrate the layout of the used street lamps 31 and show the comparison of the lighting on the ground obtained in the two conditions of FIGS. 3-5 and 4-6, in a situation corresponding to the following lighting project:
mounting height of the street lamps 31: 9 meters;
distance between the street lamps 31: 30 meters;
two-way running road with carriageway 32, bounded by the references 33, having overall width of 8 meters and centre line 34 of the carriageway 32.

According to illustrative and preferred, but not limited, embodiments of the invention, the emitter 30 with LEDs 35 uses seventy-eight LEDs, usually arranged in six rows of thirteen LEDs each, with five rows of LEDs of a first type (i.e. with asymmetric radiation pattern and emission peak at 60° in a direction longitudinal with respect to the carriageway 32) and a row of LEDs of a second type (i.e. with symmetrical radiation pattern and emitted radiation in a cone of 80-90°.

In the configuration of the appended FIG. 23 (“surround lighting”) and brightness adjustment as in the FIGS. 3 and 5, all the photometric requirements are met and the electric power absorbed by the street lamp 31 is approximately 96 Watts.

The light adjustment of the emitter 30 with LEDs 35 can be performed manually or electrically, as shown in FIGS. 17-22.

In particular, FIGS. 17 and 18 show the operation of the light adjustment carried out by an electromagnet consisting of a spindle 46, made of ferromagnetic material, around which a coil or winding 47 of copper wire run through by electrical direct current (DC) is wound.

The spindle 46 of the electromagnet is integral with a rod 48 fixed to the lever 44 of the emitter 30.

Appended FIG. 17 shows a first operating position, whereby the copper winding 47 is run across by electric current with polarity such that to generate a magnetic force directed according to the direction of the arrow F, which causes the displacement of the lever 44 of the emitter 30 in the position of FIGS. 3 and 5.

Appended FIG. 18 shows a second operating position, whereby, having driven the electric winding 47 with polarity opposite to the previous one, the magnetic force is directed according to the direction of the arrow G, and therefore, the lever 44 is displaced into the position of FIGS. 4 and 6.

FIGS. 19 and 20 illustrate the operation of the light control device with the use of a small electric motor 49, which carries a gear wheel 50, which, through a rack, controls the displacement of the adjusting lever 44 of the emitter 30 with LEDs 35.

The connecting rod with rack 51, as shown in the attached FIG. 19, is integral with the adjusting lever 44 and the rotation of the electric motor 49 moves the lever 44 in the direction of the arrows H and J, respectively.

In particular, in the attached FIG. 19, the motor 49 is driven with polarity such that to generate a anticlockwise rotation of the gear wheel 50, which creates a force directed according to the arrow H, suitable to consequently displace the lever 44 of the emitter 30 in the position of FIGS. 3 and 5.

In the appended FIG. 20, the motor 49 is driven with opposite polarity, in order to generate a clockwise rotation of the gear wheel 50, such that to create a force directed according to the arrow J, which, in turn, displaces the lever 44 of the emitter 30 in the position of FIGS. 4 and 6.

The rack device described and illustrated in FIGS. 19 and 20 can be conveniently replaced by a linear transducer with worm screw of irreversible type; in this way, once stopped feeding the motor 49, the position of the lever 44 will be automatically locked in the position reached after the displacement.

In case of driving with electric motor 49, it is possible, in any case, to position the lever 44 in any position intermediate between the extreme positions mentioned above, with the advantage of getting intermediate adjustments which can be useful for a greater versatility of the product.

The printed circuit board mounted on the bottom plate 37 may include an electronic feeder for the general operation of the lighting lamp and can be also equipped with an optional output of the management microcontroller, suitable to drive the electromagnet winding 47 of the attached FIGS. 17 and 18, or suitable to drive the electric motor 49 of the appended FIGS. 19 and 20.

In a different embodiment, the electronic feeder, which supplies DC current properly adjusted for the ignition of the LEDs 35 and incorporating the driving circuit of the winding 47 or motor 49, is housed in a weatherproof box, placed laterally of the emitter 30 and contained together with the emitter 30 inside the road armour that houses the assembly.

Even in this case, the management microcontroller, beyond to properly manage the ignition of the LEDs 35, generates driving commands of the electromagnet or motor 49.

In all the cases, the microcontroller is able to translate a radio command received in an actuation of the electromagnet or motor 49, in such a way that it is then possible to control the light adjustment in the above mentioned extreme positions of the mirrors 39, thanks to a radio command given by a central of the street lighting system or given by a PC provided with appropriate radio interface or by an operator placed near the street lamp 31.

Therefore, the adjustment of the street lamp 31 can be conveniently controlled by radio; this allows to easily adapt the light performances of the street lamp 31 to the real road configuration after its installation too, thus having the opportunity to check in real time (for instance at night, during operation) the luminous effect on the carriageway 32 in the various possible configurations.

Furthermore, the radio commands are addressable for single street lamp 31 and this allows to set different configurations for each different street lamp 31 of a carriageway 32, allowing adjustment of the light emitted at the most various operational necessities.

With reference to the appended FIGS. 21 and 22, the light adjustment can also be done manually by an operator, in case the emitter 30 does not have the servomechanisms described above.

This configuration allows to create the simplest and cheapest version of the emitter 30, which however allows great operational advantages.

Indeed, the operator is able to modify the setting by acting fro the outside of the street lamp 31, even after the installation, since the particular shape of the lever 44 allows, as shown in detail in FIGS. 21 and 22, to carry out adjustments by supporting a permanent magnet 52 on the outside of the emitter 30 and, in particular, on the closure glass 45 and thus dragging the lever 44 in the desired position.

Since the top of the lever 44 is made of ferromagnetic metallic material, the magnetic force of attraction of the external permanent magnet 52 allows to magnetically catch the lever 44 and drag it in the desired location. In addition, because the glass 45 of the emitter 30 faces the outside of the street lamp 31 and is directed downwardly on the road, it is possible to carry out the mechanical adjustment also by a rigid rod bringing the on the top a magnet 52 and which can be moved by the operator on the ground; it is therefore possible also in this case to optimally adjust the light after the completion of the installation of the street lamp 11, thanks to the adjusting device described.

In FIGS. 21 and 22 and other attached figures any appropriate retaining end-of-stroke clips are not been shown, for the sake of illustration simplicity, suitable to automatically lock the lever 44 in the extreme positions of adjustment, thanks to the use of a small release-resistant force, once reached one of the desired configurations; this mode has the aim of giving stability to the cited extreme positions and preventing that any subsequent vibrations can modify the set adjustments.

By a suitable optional optical sensor (not shown in the figures), which can be mounted on the printed circuit board installed on the bottom plate 37 and is driven by the lever 44, the microcontroller managing the lighting lamp is able to control the position of the lever 44 itself; in this way, the microcontroller identifies whether the control device is in the first position (attached FIGS. 3 and 5) or in the second position (attached FIGS. 4 and 6).

The microcontroller is therefore able to drive the LEDs 35 with proper luminous intensity, by adapting the emitted light to the selected geometric configuration of the mirrors 38, 39.

In such a way, the lighting flux emitted could be, for instance, possibly reduced in the position of FIGS. 4 and 6 (without “surround lighting”), whereby the light is fully directed inside the carriageway 32, while the overall flux could be slightly increased in the position of FIGS. 3 and 5, whereby a greater quantity of overall light in order to illuminate the edge or surround areas 36 is required.

This operating mode allows to adapt, optimally and in any configuration, the flux emitted by the street lamp 31 to the desired geometric configuration, and, therefore, allows to get in any configuration the maximum energetic efficiency of the street lamp 31 and minimum possible power consumption for meeting the required lighting requirements.

In addition, the optional optical position sensor of the lever 44 may be obtained through a photodiode mounted on the housing plate of the LEDs 35, which is obscured by a tongue of the lever 44 itself when the lever 44 is, for example, in the first position (shown in the appended FIGS. 3 and 5), while it is uncovered by such a tongue when the lever 44 is in the second position (shown in the appended FIGS. 4 and 6); in this way, when the LEDs 35 of the street lamp 31 are turned on, a large amount of light that illuminates the photodiode if the tongue uncovers the photodiode (second position), while the light on the photodiode is attenuated by the presence of the tongue in the first position.

In this way, the microcontroller of the electronic operation circuit, which analyzes the output of the photodiode, is able to recognize the position of the lever 44 and, therefore, the position of adjustment of the street lamp 31.

The technical features of the light control device for public lighting lamps, according to the present invention, as well the advantages, are clear from the description made.

It is, finally, clear that many other variations may be made to the light control device in question, without departing from the principle of novelty intrinsic in the inventive idea expressed here, as it is clear that, in the practical implementation of the invention, materials, shapes and sizes of the illustrated details can be changed, as needed, and replaced with others technically equivalent.

1. Light control device for public lighting lamps (31), which are installed on carriageways (32) and provided with at least one light emitter (30) comprising a plurality of light sources (35) and a plurality of reflectors or mirrors (38, 39) housed inside at least one casing laterally bounded by closure sides (41, 42), characterized by the fact that said reflectors or mirrors (38, 39) include a first set of reflectors (38) having a surface with fixed inclination and a second set of reflectors (39) having a surface with adjustable inclination, said reflectors (39) with adjustable inclination being pivoted on relative shafts (40), which are sliding along fixed cams (43) that correspond to respective grooves made in said closure sides (41, 42) and in the lateral walls of at least one sliding lever (44), which, by shifting with respect to said sides (41, 42), with said cams (43) fixed, determines the inclination of said second set of reflectors (39).

2. Light control device as claimed in claim 1, characterized by the fact that said casing has at least one closure glass (45), which is placed upon said reflectors (38, 39), and/or at least one bottom plate (37), which accommodates an electronic circuit for the operation of the public lighting lamp.

3. Light control device as claimed in claim 1, characterized by the fact that respective heat sinks are placed in correspondence of at least two of said closure sides (41, 42).

4. Light control device as claimed in claim 1, characterized by the fact that said reflectors (39) having an adjustable inclined surface are directed towards a first initial position, towards a second final position and in intermediate positions between said initial position and said final position.

5. Light control device as claimed in claim 1, characterized by the fact that said reflectors (39) having an adjustable inclined surface have a different inclination with respect to the inclination of said reflectors (38) having a fixed inclined surface and the inclination of said reflectors (39) having an adjustable inclined surface, which is set at said first initial position, allows to direct the light of said light sources (35) to the carriageway (32) and to the side areas (36) which are provided laterally to the carriageway (32).

6. Light control device as claimed in claim 1, characterized in that said reflectors (38) having a fixed inclined surface are directed so as to direct the light of said light sources (35) exclusively within the carriageway (32).

7. Light control device as claimed in claim 4, characterized in that said reflectors (39) having an adjustable inclined surface have an inclination equal to the inclination of said reflectors (38) having a fixed inclined surface and the inclination of said reflectors (39) having an adjustable inclined surface, which is set at said second final position, allows to direct the light of said light sources (35) exclusively to the carriageway (32).

8. Light control device as claimed in claim 1, characterized by the fact that said light sources (35) are constituted by a plurality of LEDs, wherein a first set of LEDs shows an asymmetrical radiation pattern with an emission peak in the longitudinal direction with respect to the carriageway (32) and a second set of LEDs shows a symmetrical radiation pattern and radiation emitted in a cone of a fixed angle.

9. Light control device as claimed in claim 4, characterized by the fact that said sliding lever (44) is fixed to at least one rod (48) which is integral with a spindle (46) of an electromagnet with a magnetic force directed to move, according to prefixed directions (F, G), said sliding lever (44), so that said reflectors (39) having an adjustable inclined surface are moved between said first initial position and said second final position.

10. Light control device as claimed in claim 4, characterized by the fact that said sliding lever (44) is driven by at least one connecting rod with rack (51), on which at least one gear wheel (50) runs, said gear wheel (50) being associated with at least one electric motor (49), whose rotation moves, according to prefixed directions (H, J), said sliding lever (44), so that said reflectors (39) having an adjustable inclined surface are moved between said first initial position and said second final position.

11. Light control device as claimed in claim 4, characterized by the fact that said sliding lever (44) is driven by at least one linear transducer with a worm screw of the irreversible type, on which at least one gear wheel (50) runs, said gear wheel (50) being associated with at least one electric motor (49), whose rotation moves, according to prefixed directions (H, J), said sliding lever (44), so that said reflectors (39) having an adjustable inclined surface are moved between said first initial position and said second final position.

12. Light control device as claimed in claim 4, characterized by the fact that said sliding lever (44) is manually actuated by at least one magnet (52), which slides, externally to said emitter (30), between said first initial position and said second final position and in front of said sliding lever (44), said sliding lever (44) being made, at least partially, in ferromagnetic metallic materials.

13. Light control device as claimed in claim 12, characterized by the fact that said magnet (52) is fixed on top of a shaft which is moved by an operator standing on the ground.

14. Light control device as claimed in claim 4, characterized by the fact that said device includes at least one optical sensor, which is driven by said sliding lever (44), so that a microcontroller is able to control the position of said sliding lever (44) and therefore said light sources (35), by adjusting the intensity of the emitted light to the geometry of said reflectors or mirrors (38, 39).

15. Light control device as claimed in claim 14, characterized by the fact that said optical sensor which detects the position of said sliding lever (44) is made by a photodiode, which is covered by a tab of said sliding lever (44) when said sliding lever (44) is moved towards said first initial position or towards said second final position and which is uncovered by said tab when said sliding lever (44) is moved, respectively, towards said second final position or towards said first initial position, so that said microcontroller, which controls the output of said photodiode, is able to recognize the position of said sliding lever (44).
